(19) United States
(12) Patent Application Publication
(10) Pub. No.: US 2026/0058337 A1
(43) Pub. Date: Feb. 26, 2026

(54) Secondary Battery and Battery Pack Including the Same

(71) Applicant: SK On Co., Ltd., Seoul (KR)

(72) Inventors: Seung Ho KWAK, Seoul (KR); Soo Min PARK, Seoul (KR); Jae Yun PARK, Seoul (KR); Joo Hyuk LEE, Seoul (KR); Myeong Shin CHO, Seoul (KR); Soo In PARK, Gyeonggi-do (KR)

(21) Appl. No.: 19/303,486

(22) Filed: Aug. 19, 2025

(30) Foreign Application Priority Data
Aug. 21, 2024 (KR) 10-2024-0112106

(51) Int. Cl. H01M 50/559; H01M 10/04; H01M 50/107; H01M 50/567; H01M 50/586; H01M 50/59

(52) U.S. Cl. CPC H01M 50/559; H01M 10/0431; H01M 50/107; H01M 50/567; H01M 50/586; H01M 50/59

(57) ABSTRACT

A secondary battery and a battery pack including the same are disclosed. According to one aspect of the present disclosure, there is provided a secondary battery including a can, an electrode assembly disposed inside the can, and a rivet provided on one surface of the can and electrically connected to a first electrode of the electrode assembly, wherein the rivet is formed so that rotation around a rivet axis is supported by the can.

### CROSS-REFERENCE TO RELATED APPLICATION

This application claims priority to and the benefit of Korean Patent Application No. 10-2024-0112106, filed on Aug. 21, 2024, the disclosure of which is incorporated herein by reference in its entirety.

### BACKGROUND

### 1. Field of the Invention

An embodiment of the present disclosure relates to a secondary battery and a battery pack including the same.

### 2. Discussion of Related Art

A secondary battery is known as one of the energy storage means which can be charged and discharged through electrochemical reactions. The secondary battery is widely utilized in various fields in which electrical energy is used. For example, secondary batteries are widely utilized in mobile devices such as a cell phone, a notebook, a tablet, and the like, and are being explored for wider utilization in the field of transportation means such as vehicles, aircraft, ships, and the like. Further, demand for secondary batteries is increasing in the field of energy storage systems (ESSs) for utilizing surplus electricity.

Secondary batteries can be classified into pouch types, prismatic types, cylindrical types, and coin types depending on the packaging form. Demand for cylindrical secondary batteries has been rapidly increasing in recent years in the vehicle field due to relatively low manufacturing costs. The cylindrical secondary battery may have a structure in which an electrode assembly called a jelly roll is accommodated in a can together with an electrolyte. The electrode assembly may have a structure where a positive electrode and a negative electrode with a sheet shape are disposed with a separator therebetween and are wound in a roll shape.

The secondary battery may be exposed to various external forces. For example, a secondary battery used in a vehicle or the like may be exposed to continuous vibrations or external forces depending on the operation of the vehicle. In addition, the secondary battery may be subjected to an external force due to interference with other components during the manufacturing or assembly process. In some cases, various types of external forces acting on the secondary battery may affect the performance or quality of the secondary battery. For example, a secondary battery that is continuously exposed to vibrations or an external force may have problems, such as electrical disconnection or degradation of sealing performance.

### SUMMARY OF THE INVENTION

Some embodiments of the present disclosure are directed to providing a secondary battery and a battery pack including the same.

In addition, some embodiments of the present disclosure are directed to providing a secondary battery capable of improving a bonding structure of a rivet and a battery pack including the same.

At least some embodiments of the present disclosure may be widely applied in the field of green technologies such as an electric vehicle and a battery charging station as well as solar power generation and wind power generation using batteries. Further, at least some embodiments of the present disclosure may be used in an eco-friendly electric vehicle, a hybrid vehicle, and the like to prevent climate change by suppressing air pollution and greenhouse gas emissions.

According to an aspect of the present disclosure, there is provided a secondary battery including a can, an electrode assembly disposed inside the can, and a rivet provided on one surface of the can and electrically connected to a first electrode of the electrode assembly, wherein the rivet is configured so that rotation around a rivet axis is supported by the can.

In some embodiments, the can may include a first rotational support surface that restricts rotation of the rivet.

In some embodiments, the first rotational support surface may be provided on a bent rib formed by bending a portion of the can.

In some embodiments, the bent rib may be formed by being bent toward an outside of the can.

In some embodiments, the first rotational support surface may be formed as a plane parallel to the rivet axis.

In some embodiments, the rivet may include a second rotational support surface supported on the can to restrict rotation of the rivet.

In some embodiments, the second rotational support surface may be formed in a form in which a side surface of the rivet is partially cut.

In some embodiments, the rivet may have a side surface formed to extend in a circumferential direction centered on the rivet axis.

In some embodiments, the second rotational support surface may be formed in a form in which the side surface is partially cut along a predetermined chord.

In some embodiments, the second rotational support surface may be formed to have a center angle of 30 to 120 degrees centered on the rivet axis in a plan view.

In some embodiments, the second rotational support surface may be formed as a plane parallel to the rivet axis.

In some embodiments, the rivet may include a lower area disposed inside the can and electrically connected to the first electrode, a central area extending from the lower area toward an outside of the can, and an upper area extending from the central area to form an upper end of the rivet.

In some embodiments, the second rotational support surface may be partially provided in the central area.

In some embodiments, the upper area may be formed in a circular shape centered on the rivet axis in a plan view, and the second rotational support surface may be formed in a shape in which the circular shape is partially cut along a predetermined chord in a plan view.

In some embodiments, the secondary battery may further include a gasket provided between the rivet and the can to electrically insulate the rivet and the can.

In some embodiments, the can may be formed in a cylindrical shape, and the electrode assembly may be formed by winding the first electrode and a second electrode in a roll shape with a separator interposed therebetween.

In some embodiments, the electrode assembly may include a first electrode surface formed by bending a plurality of first electrode tabs toward a central axis at one surface of the electrode assembly, and a second electrode surface formed by bending a plurality of second electrode tabs toward the central axis at an opposite surface corresponding to the one surface.

According to another aspect of the present disclosure, there is provided a battery pack including the secondary battery described above.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic perspective view of a secondary battery according to one embodiment of the present disclosure;

FIG. 2 is a schematic cross-sectional view of the secondary battery shown in FIG. 1;

FIG. 3 is a schematic perspective view of an electrode assembly shown in FIG. 2;

FIG. 4 is an enlarged view of a rivet shown in FIG. 2;

FIG. 5 is a schematic cross-sectional view taken along line C1-C1 shown in FIG. 4;

FIG. 6 is a schematic perspective view of a secondary battery according to another embodiment of the present disclosure;

FIG. 7 is a schematic cross-sectional view of a rivet shown in FIG. 6; and

FIG. 8 is a schematic perspective view of a battery pack according to one embodiment of the present disclosure.

### DETAILED DESCRIPTION OF EXEMPLARY EMBODIMENTS

Hereinafter, the present disclosure will be described in detail with reference to the accompanying drawings. However, this is merely exemplary, and the present disclosure is not limited to the exemplified specific embodiments.

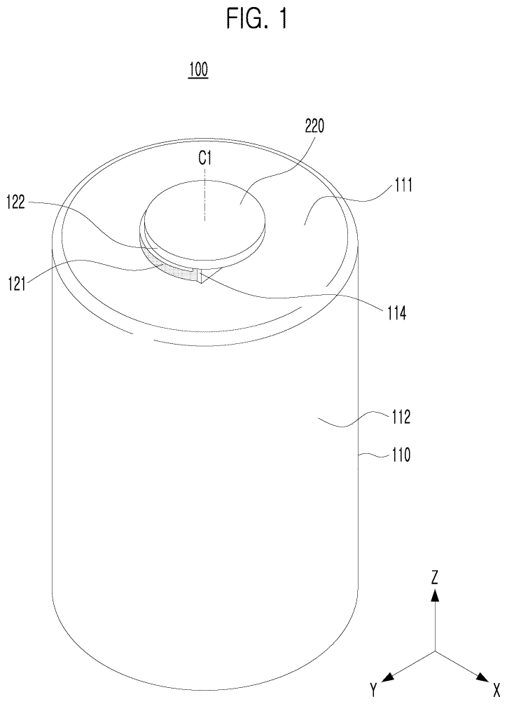

FIG. 1 is a schematic perspective view of a secondary battery according to one embodiment of the present disclosure.

For convenience of description, an x-axis direction is referred to as a left-right direction, a y-axis direction is referred to as a front-back direction, and a z-axis direction is referred to as an up-down direction based on the coordinate axes shown in FIG. 1. In addition, a rotation direction around a central axis C1 is referred to as a circumferential direction, and a direction extending along the xy plane from the central axis C1 is referred to as a radial direction based on the central axis C1 shown in FIG. 1.

Referring to FIG. 1, in some embodiments, a secondary battery 100 may be formed in a cylindrical shape. The cylindrical secondary battery 100 may have a vertical central axis C1. In addition, the cylindrical secondary battery 100 may have a predetermined diameter and height. For example, the secondary battery 100 may have a diameter of about 46 mm and a height of about 80 mm. In the art, the secondary battery 100 having such a form factor may be referred to as a ‘4680 battery.’ As another example, the secondary battery 100 may have a diameter of about 46 mm and a height of about 80 mm, a diameter of about 46 mm and a height of about 95 mm, or a diameter of about 46 mm and a height of about 110 mm. In the art, the secondary battery 100 having such a form factor may be referred to as a ‘46xx battery.’ In the ‘46xx’, ‘xx’ may describe a height of the corresponding form factor. As still another example, the secondary battery 100 may have a diameter of about 48 mm and a height of about 75 mm, a diameter of about 48 mm and a height of about 80 mm, or a diameter of about 48 mm and a height of about 110 mm. In the art, the secondary battery 100 having such a form factor may be referred to as a ‘48xx battery.’ In the ‘48xx’, ‘xx’ may describe a height of the corresponding form factor. However, the specific diameter and height of the secondary battery 100 may be variously modified as necessary, and are not necessarily limited to those exemplified.

Meanwhile, although the cylindrical secondary battery 100 is illustrated in the present description, the form factor of the secondary battery 100 according to the embodiments of the present disclosure is not necessarily limited to the cylindrical type. The secondary battery 100 according to the embodiments of the present disclosure may be implemented or applied as various form factors, such as a coin type, a prismatic type, a pouch type, and the like, within the scope including the technical idea to be described below.

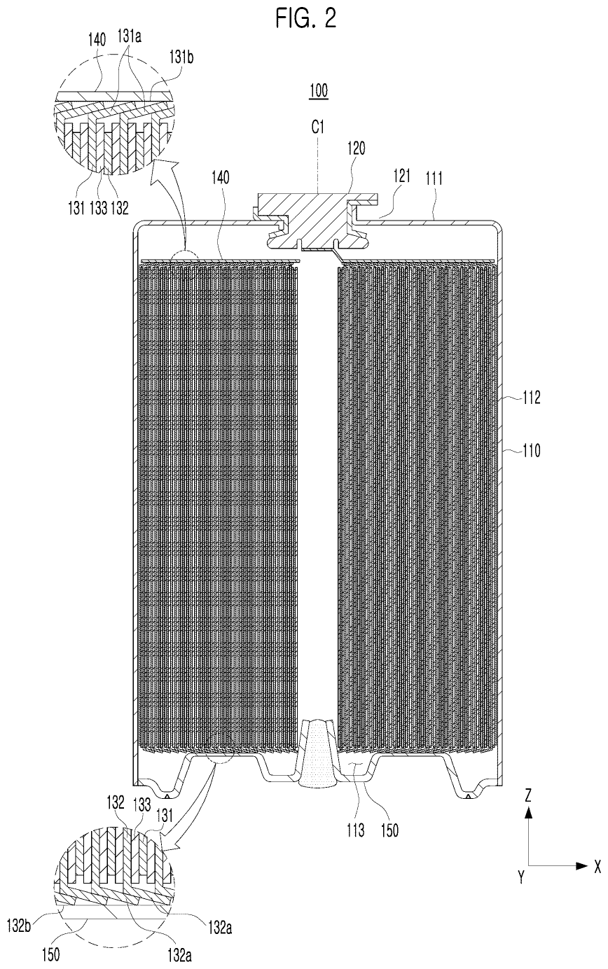

In some embodiments, the secondary battery 100 may include a can 110. The can 110 may form an overall exterior of the secondary battery 100. In addition, the can 110 may form an inner space for the arrangement of an electrode assembly 130 to be described below. The can 110 may include an upper surface portion 111 and a side surface portion 112. The side surface portion 112 of the can 110 may extend in a circumferential direction while forming a cylindrical side surface. In addition, the can 110 may have an opening 113 on a lower side (see FIG. 2). The opening 113 may be closed by a cap plate 150 to be described below.

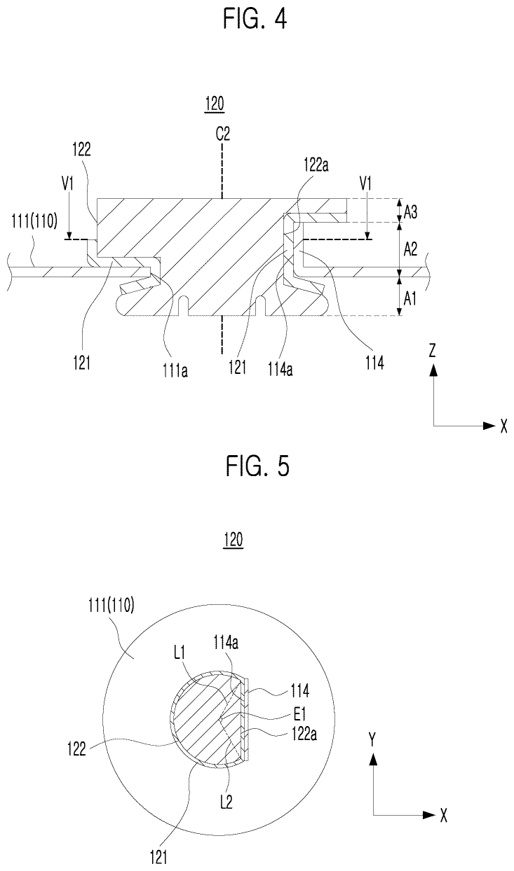

In some embodiments, the secondary battery 100 may include a rivet 120. The rivet 120 may be disposed on the upper surface portion 111 of the can 110. The rivet 120 may function as an electrode terminal. That is, the rivet 120 may function as a positive electrode terminal or a negative electrode terminal. In the present description, it is described that the rivet 120 is a first electrode terminal. The first electrode terminal may be, for example, a positive electrode terminal. The detailed configuration of the rivet 120 will be described below through FIG. 4 or the like.

In some embodiments, at least a portion of the can 110 may be formed of a conductive material. Alternatively, at least a portion of the can 110 may be formed of a conductive metal material. For example, the can 110 may be formed by deep drawing processing of integrated stainless steel.

In some embodiments, the can 110 may function as another electrode terminal of which a partial area corresponds to the rivet 120. That is, a partial area of the can 110 may function as a negative electrode terminal corresponding to the rivet 120 or a positive electrode terminal corresponding to the rivet 120. In the present description, it is described that the partial area of the can 110 is a second electrode terminal. The second electrode terminal may be, for example, a negative electrode terminal. In some embodiments, a partial area of the upper surface portion 111 of the can 110 may function as the second electrode terminal. That is, in the can 110, the remaining area of the upper surface portion 111 except for the area in which the rivet 120 is disposed may function as the second electrode terminal. The upper surface portion 111 may be electrically insulated from the rivet 120 by a gasket 121 formed of an insulator.

FIG. 2 is a schematic cross-sectional view of the secondary battery shown in FIG. 1.

Referring to FIG. 2, in some embodiments, the secondary battery 100 may include the electrode assembly 130. The electrode assembly 130 may be disposed inside the can 110. The electrode assembly 130 may be formed to have a shape and size corresponding to the inner space of the can 110 to increase energy density. For example, the electrode assembly 130 may be formed in a cylindrical roll shape that occupies most of the inner space of the can 110.

In some embodiments, the electrode assembly 130 may include a first electrode 131 and a second electrode 132 with a separator 133 interposed therebetween. The first electrode 131 may be a positive electrode or a negative electrode, and the second electrode 132 may be a negative electrode or a positive electrode corresponding to the first electrode 131. In the present description, it is assumed that the first electrode 131 is a positive electrode and the second electrode 132 is a negative electrode.

In some embodiments, the first electrode 131 may include a positive electrode current collector. For example, the positive electrode current collector may include aluminum, stainless steel, nickel, titanium, or an alloy thereof. In another example, the positive electrode current collector may include aluminum or stainless steel surface-treated with nickel, titanium, carbon, silver, or a combination thereof. In another example, the positive electrode current collector may include a polymer substrate coated with a conductive metal.

In some embodiments, the first electrode 131 may include a positive electrode mixture layer provided on at least one surface of the positive electrode current collector. The positive electrode mixture layer may include a positive electrode active material. The positive electrode active material may include a compound capable of reversibly intercalating and deintercalating lithium ions. For example, the positive electrode active material may include a lithium-nickel metal oxide. Optionally, the lithium-nickel metal oxide may further include cobalt, manganese, aluminum, or a combination thereof. Optionally, the positive electrode mixture layer may further include at least one of a binder, a conductive material, and a thickener.

In some embodiments, the second electrode 132 may include a negative electrode current collector. For example, the negative electrode current collector may include copper, stainless steel, nickel, titanium, of an alloy thereof. In another example, the negative electrode current collector may include copper or stainless steel surface-treated with nickel, titanium, carbon, silver, or a combination thereof. In another example, the negative electrode current collector may include a polymer substrate coated with a conductive metal.

In some embodiments, the second electrode 132 may include a negative electrode mixture layer provided on at least one surface of the negative electrode current collector. The negative electrode mixture layer may include a negative electrode active material. The negative electrode active material may include a compound capable of reversibly intercalating and deintercalating lithium ions. For example, the negative electrode active material may include a carbon-based material such as crystalline carbon, amorphous carbon, a carbon composite, and a carbon fiber, lithium metal, a lithium alloy, a silicon-containing material or a tin-containing material. Optionally, the negative electrode mixture layer may further include at least one of a binder, a conductive material, and a thickener.

In some embodiments, the separator 133 may be provided between the first and second electrodes 131 and 132. The separator 133 may prevent an electrical short circuit between the first and second electrodes 131 and 132 to generate the flow of ions. In some embodiments, the separator 133 may include a porous polymer film, a porous nonwoven fabric, or the like. The porous polymer film may include, for example, a polyolefin-based polymer such as an ethylene polymer, a propylene polymer, an ethylene/butene copolymer, an ethylene/hexene copolymer, and an ethylene/methacrylate copolymer. In addition, the porous nonwoven fabric may include, for example, high-melting glass fibers, polyethylene terephthalate fibers, and the like. In some embodiments, the separator 133 may include a ceramic-based material. For example, the separator 133 may be formed by coating inorganic particles on a polymer film or dispersing inorganic particles within a polymer film. In some embodiments, the separator 133 may have a single layer or multilayer structure including a polymer film and/or a nonwoven fabric.

In some embodiments, the electrode assembly 130 as described above may be provided by winding the first and second electrodes 131 and 132 and the separator 133 around a central axis C1. The electrode assembly 130 may be provided in the form of a cylindrical roll, and may be referred to as a jelly roll in the art.

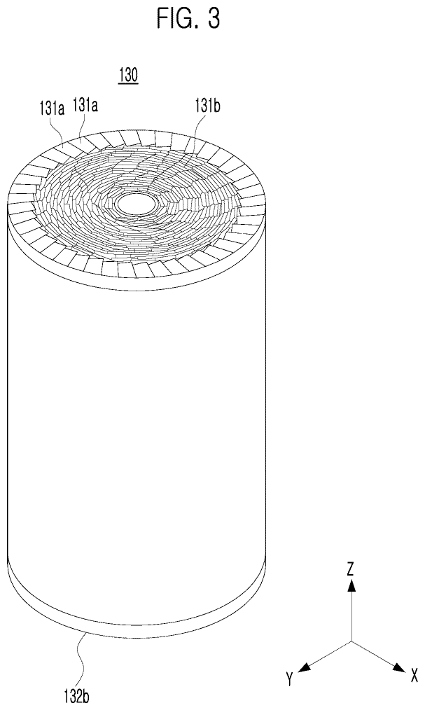

Meanwhile, in some embodiments, the electrode assembly 130 may include a first electrode tab 131a. The first electrode tab 131a may be formed to extend from the first electrode 131. In the illustrated embodiment, the first electrode tab 131a may function as a positive electrode tab, and is provided at an upper end portion of the positive electrode current collector from which the positive electrode mixture layer is omitted. That is, the first electrode tab 131a is disposed at an upper end portion of the electrode assembly 130. In some embodiments, a plurality of first electrode tabs 131a may be provided. The plurality of first electrode tabs 131a may be disposed in a longitudinal direction in which the first electrode 131 is wound. In addition, the plurality of first electrode tabs 131a may be bent toward the central axis C1. The plurality of bent first electrode tabs 131a may form a first electrode surface 131b at the upper surface of the electrode assembly 130 (see FIG. 3).

In addition, in some embodiments, the electrode assembly 130 may include a second electrode tab 132a. The second electrode tab 132a may be formed to extend from the second electrode 132. In the illustrated embodiment, the second electrode tab 132a may function as a negative electrode tab, and is provided at a lower end portion of the negative electrode current collector from which the negative electrode mixture layer is omitted. That is, the second electrode tab 132a is disposed at a lower end portion of the electrode assembly 130. Similar to the first electrode tab 131a, in some embodiments, a plurality of second electrode tabs 132a may be provided. The plurality of second electrode tabs 132a may be disposed in a longitudinal direction in which the second electrode 132 is wound. In addition, the plurality of second electrode tabs 132a may be bent toward the central axis C1. The plurality of bent second electrode tabs 132a may form a second electrode surface 132b at the lower surface of the electrode assembly 130 (see FIG. 3).

Meanwhile, in some embodiments, the first electrode tab 131a may be electrically connected to the rivet 120. Accordingly, the rivet 120 may function as a first electrode terminal. That is, in the illustrated embodiment, the rivet 120 may function as a positive electrode terminal. In some embodiments, the first electrode tab 131a may be electrically connected to the rivet 120 through a current collector plate 140. The current collector plate 140 may be disposed between the first electrode tab 131a and the rivet 120 in an inner upper portion of the can 110. The current collector plate 140 may be bonded to the first electrode tab 131a at the first electrode surface 131b and may be bonded to the rivet 120 at a lower end of the rivet 120. For example, the current collector plate 140 may be welded to the first electrode tab 131a and the rivet 120.

In some embodiments, the second electrode tab 132a may be electrically connected to the can 110. In the illustrated embodiment, the second electrode tab 132a is electrically connected to the can 110 through the cap plate 150. In some embodiments, the second electrode tab 132a may be directly bonded to the cap plate 150 to be electrically connected to the cap plate 150. That is, in the electrical connection of the second electrode tab 132a, the current collector plate 140 as described above may be appropriately omitted. For example, the second electrode tab 132a may be welded to the cap plate 150 at the second electrode surface 132b. However, the present disclosure is not necessarily limited thereto, and in some cases, a connecting part such as a current collector plate and the like may be appropriately used for electrical connection of the second electrode tab 132a.

Meanwhile, in some embodiments, the secondary battery 100 may include the cap plate 150. The cap plate 150 may be formed to close the opening 113 of a lower side of the can 110. In some embodiments, the cap plate 150 may be welded to the lower end of the can 110 and joined to the can 110. The inside of the can 110 may be properly sealed by the rivet 120 at the top and the cap plate 150 at the bottom with the electrode assembly 130 accommodated therein.

FIG. 3 is a schematic perspective view of the electrode assembly shown in FIG. 2.

Referring to FIG. 3, in some embodiments, the plurality of first electrode tabs 131a bent toward the central axis C1 may form the first electrode surface 131b at the upper surface of the electrode assembly 130. The first electrode surface 131b may be formed as a schematic surface formed by the plurality of bent first electrode tabs 131a. As described above, the current collector plate 140 may be bonded to the first electrode tab 131a at the first electrode surface 131b. Similarly, the plurality of second electrode tabs 132a bent toward the central axis C1 may form the second electrode surface 132b at the lower surface of the electrode assembly 130. The second electrode surface 132b may be formed as a schematic surface formed by the plurality of bent second electrode tabs 132a. As described above, the cap plate 150 may be bonded to the second electrode tab 132a at the second electrode surface 132b.

FIG. 4 is an enlarged view of the rivet shown in FIG. 2.

Referring to FIG. 4, in some embodiments, the secondary battery 100 may include the can 110, the electrode assembly 130 disposed inside the can 110, and the rivet 120 provided on one surface of the can 110 and electrically connected to the first electrode of the electrode assembly 130. Here, the rivet 120 may be configured such that rotation about a rivet axis C2 is supported by the can 110.

Specifically, in some embodiments, the secondary battery 100 may include the rivet 120, and the rivet 120 may be electrically connected to the first electrode of the electrode assembly 130. In the illustrated embodiment, the rivet 120 is electrically connected to the first electrode tab 131a through the current collector plate 140 as described above.

In some embodiments, the rivet 120 may include the rivet axis C2. The rivet axis C2 may be defined as an axis in a vertical direction passing through the center of the rivet 120. In the illustrated embodiment, the rivet 120 is disposed at the center of the can 110, and accordingly, the rivet axis C2 may be formed as an axis in a vertical direction corresponding to the central axis C1 of the secondary battery 100. According to the rivet axis C2, a rotation direction of the rivet 120 about the rivet axis C2 may be defined. Hereinafter, the rotation of the rivet 120 may refer to rotation about the rivet axis C2.

In some embodiments, the rivet 120 may receive an external force in the rotation direction. For example, the rivet 120 may receive an external force in the rotation direction by interference between internal components, an external force due to external components such as a bus bar, or an external force due to external environmental factors during use. Such an external force in the rotation direction may be accumulated in the bonding structure between the rivet 120 and the can 110, and as a result, may contribute to weakening the bonding force between the rivet 120 and the can 110. In addition, the weakening of the bonding force between the rivet 120 and the can 110 may cause the possibility of electrical disconnection due to the movement (rotation) of the rivet 120 and deterioration of the sealing performance between the rivet 120 and the can 110.

In some embodiments, the above problem may be improved by supporting the rotation of the rivet 120 by the can 110. Here, the rivet 120 may be formed such that the rotation about the rivet axis C2 is supported by the can 110. Accordingly, the rotation of the rivet 120 may be appropriately limited despite internal and external interference or external forces. In addition, problems caused by the movement (rotation) of the rivet 120 may be improved.

Specifically, in some embodiments, the can 110 may include a first rotational support surface 114a. The first rotational support surface 114a may function to support the rotation of the rivet 120. That is, the rivet 120 may be supported by the first rotational support surface 114a, and thus the rotation about the rivet axis C2 may be restricted.

In some embodiments, the first rotational support surface 114a may be provided on a bent rib 114. Here, the bent rib 114 may be formed by bending a portion of the can 110. Specifically, the can 110 may have a rivet hole 111a formed through the upper surface portion 111, and the rivet 120 may be fastened to the rivet hole 111a. Here, the can 110 may include the bent rib 114 at a portion of an outer circumference of the rivet hole 111a. The bent rib 114 may extend from the upper surface portion 111 of the can 110 and may be integrally formed with the can 110. In addition, the bent rib 114 may be bent at a predetermined angle with the other area of the upper surface portion 111. For example, the bent rib 114 may be bent to be substantially perpendicular to the other area of the upper surface portion 111, as in the illustrated embodiment.

The first rotational support surface 114a may be provided on one surface of the bent rib 114 described above. That is, the bent rib 114 may have an inner surface disposed toward the rivet axis C2 and an outer surface disposed toward the opposite side of the inner surface, and the first rotational support surface 114a may be provided on the inner surface of the bent rib 114. In other words, the inner surface of the bent rib 114 may function as the first rotational support surface 114a by supporting a side surface 122 of the rivet 120.

In some embodiments, the bent rib 114 may be formed by being bent upward toward the outside of the can 110. Specifically, the can 110 may include an inside where the electrode assembly 130 is disposed and an outside opposite thereto, and the bent rib 114 may be bent upward from the upper surface portion 111 of the can 110 toward the outside of the can 110. Such a bent rib 114 may have an advantage in that the bent rib 114 does not occupy the inner space of the can 110. That is, it is possible to prevent a case in which an arrangement space of the electrode assembly 130 is limited due to the bent rib 114, or a case in which there is a limitation on the design of an air gap between the electrode assembly 130 and the upper surface portion 111.

In some embodiments, the first rotational support surface 114a may be formed as a plane parallel to the rivet axis C2. Specifically, in the illustrated embodiment, the rivet axis C2 may be formed as an axis in the vertical direction, and the bent rib 114 may be bent to be substantially perpendicular to the other area of the upper surface portion 111 to extend in the vertical direction. In addition, the first rotational support surface 114a may be formed on one surface (inner surface) of the bent rib 114, and may be formed as a plane parallel to the vertical direction. In other words, the first rotational support surface 114a may be formed as a plane parallel to the rivet axis C2. The first rotational support surface 114a may more effectively support the rivet 120 in response to the rotation of the rivet 120 centered on the rivet axis C2.

Meanwhile, in some embodiments, the rivet 120 may be provided with a second rotational support surface 122a corresponding to the first rotational support surface 114a as described above. The second rotational support surface 122a provided on the rivet 120 may be supported by the first rotational support surface 114a provided on the can 110 and may function to restrict the rotation of the rivet 120.

Similar to the first rotational support surface 114a described above, in some embodiments, the second rotational support surface 122a may be formed as a plane parallel to the rivet axis C2. Specifically, the rivet 120 may have a side surface 122 extending parallel to the rivet axis C2, and the second rotational support surface 122a may be provided on the side surface 122 of the rivet 120. In addition, the second rotational support surface 122a may be formed by partially cutting the side surface 122 of the rivet 120 to have a flat shape. The second rotational support surface 122a may be supported by the first rotational support surface 114a in the corresponding planar area to more effectively support the rotation of the rivet 120 centered on the rivet axis C2. A detailed configuration of the second rotational support surface 122a will be described in detail below with reference to FIG. 5.

Meanwhile, in some embodiments, the rivet 120 may have a lower area A1, a central area A2, and an upper area A3 along the vertical direction. The lower area A1 may form a lower portion of the rivet 120. The lower area A1 may be disposed inside the can 110. In other words, the lower area A1 may be defined as a lower portion of the rivet 120 disposed inside the can 110. When the rivet 120 is assembled through the rivet hole 111a, the lower area A1 may be appropriately deformed by a predetermined pressing part to fix and support the rivet 120 to the upper surface portion 111 of the can 110.

The central area A2 may extend from an upper end of the lower area A1 toward the outside of the can 110. The central area A2 may be disposed between the lower area A1 on the lower side and the upper area A3 on the upper side. In other words, the central area A2 may be defined as a central portion of the rivet 120 disposed between the lower area A1 and the upper area A3. Alternatively, the central area A2 may be defined as a portion in the vertical direction of the rivet 120 provided with the second rotational support surface 122a in relation to the second rotational support surface 122a to be described below. The center area A2 may extend from the upper surface portion 111 of the can 110 toward the outside of the can 110 and may be disposed outside the can 110.

In some embodiments, the second rotational support surface 122a as described above may be partially provided in the central area A2. In other words, the second rotational support surface 122a may extend vertically within the central area A2 and may be appropriately omitted in the lower area A1 and the upper area A3. From this perspective, the central area A2 may be defined as a portion in the vertical direction of the rivet 120 with the second rotational support surface 122a. The central area A2 may extend vertically in a predetermined range so that the second rotational support surface 122a may have an appropriate support force. For example, the central area A2 may extend vertically to be 50% or more of the height of the rivet 120 exposed to the outside of the upper surface portion 111 of the can 110. Alternatively, the central area A2 may have a height in the vertical direction greater than the height of the upper area A3.

Meanwhile, the upper area A3 may be formed to extend to a predetermined height from the upper end of the central area A2. The upper area A3 may form an upper end of the rivet 120. In other words, the upper surface of the upper area A3 may correspond to the upper surface of the rivet 120. Accordingly, the upper area A3 may be defined as an upper area portion ranging from the upper end of the central area A2 to the upper end of the rivet 120.

In some embodiments, the upper area A3 may be formed in a circular shape centered on the rivet axis C2 in a plan view. Alternatively, the rivet 120 may be formed in a circular shape centered on the rivet axis C2 in a plan view. The rivet 120 may have the side surface 122 extending in a circumferential direction centered on the rivet axis C2. Here, the second rotational support surface 122a may be formed in a shape in which the circular shape formed by the upper area A3 is partially cut along a predetermined chord in the central area A2. In other words, the second rotational support surface 122a may be formed by setting two arbitrary points along the circumference of the circular shape, and cutting a portion of the side surface 122 of the rivet 120 based on the chord connecting the points.

The upper area A3 of the rivet 120 as described above may have a circular shape in a plan view. In addition, the central area A2 may be formed in a shape in which the circular shape is partially cut. Accordingly, despite the addition of the second rotational support surface 122a, the upper surface of the rivet 120 (i.e., the upper surface of the upper area A3) may maintain a circular shape in a plan view. That is, the upper surface of the rivet 120 may have a symmetrical circular shape, and the possibility that the arrangement direction of the rivet 120 may be an obstacle in electrical connection with other secondary batteries may be excluded.

Meanwhile, in some embodiments, the secondary battery 100 may include the gasket 121 electrically insulating the rivet 120 from the can 110. When the upper surface portion 111 of the can 110 is used as a second electrode terminal, the rivet 120 functioning as the first electrode terminal may be appropriately insulated from the upper surface portion 111 of the can 110 by the gasket 121. In the illustrated embodiment, the gasket 121 is fastened to the side surface 122 of the rivet 120 and has an asymmetrical shape in the left and right directions along the second rotational support surface 122a provided in the rivet 120. The gasket 121 may include various shapes, materials, methods, and the like as long as it may provide appropriate electrical insulation between the rivet 120 and the can 110, and is not necessarily limited to what is illustrated.

FIG. 5 is a schematic cross-sectional view taken along line V1-V1 shown in FIG. 4.

Referring to FIG. 5, in some embodiments, the second rotational support surface 122a may be formed in a shape in which the side surface 122 of the rivet 120 is partially cut. Specifically, the side surface 122 of the rivet 120 may be formed to extend along the circumferential direction centered on the rivet axis C2. In addition, the second rotational support surface 122a may be formed in a shape in which the side surface 122 of the rivet 120 is partially cut along a predetermined chord. The second rotational support surface 122a is similar to that described through the central area A2 of the rivet 120 described above.

The second rotational support surface 122a as described above may be supported by the first rotational support surface 114a provided on the upper surface portion 111 of the can 110. That is, in the illustrated embodiment, the rivet 120 may be supported by the upper surface portion 111 in a chord area corresponding to the first and second rotational support surfaces 114a and 121a. Accordingly, the rotation of the rivet 120 around the rivet axis C2 may be limited, and problems such as disconnection and sealing damage due to the rotation of the rivet 120 may be improved.

Meanwhile, in some embodiments, the rivet 120 may have an approximately circular shape in a plan view, and the second rotational support surface 122a may have a shape in which the circular shape is partially cut along a predetermined chord. The second rotational support surface 122a may have a predetermined central angle E1 centered on the rivet axis C2 in a plan view. Specifically, the central angle E1 may refer to an angle between a first extension line L1 connecting one end of the second rotational support surface 122a and the rivet axis C2 and a second extension line L2 connecting an opposite end portion of the second rotational support surface 122a and the rivet axis C2.

In some embodiments, the central angle E1 of the second rotational support surface 122a may be formed to be 30 to 120 degrees. For example, when the central angle E1 is less than 30 degrees, an appropriate support area may not be secured between the first and second rotational support surfaces 114a and 122a, and the rotation restriction function of the rivet 120 may be degraded. In addition, when the central angle E1 is greater than 120 degrees, the cross-sectional area of the rivet 120 may be excessively reduced, which may adversely affect the rigidity and current carrying performance of the rivet 120.

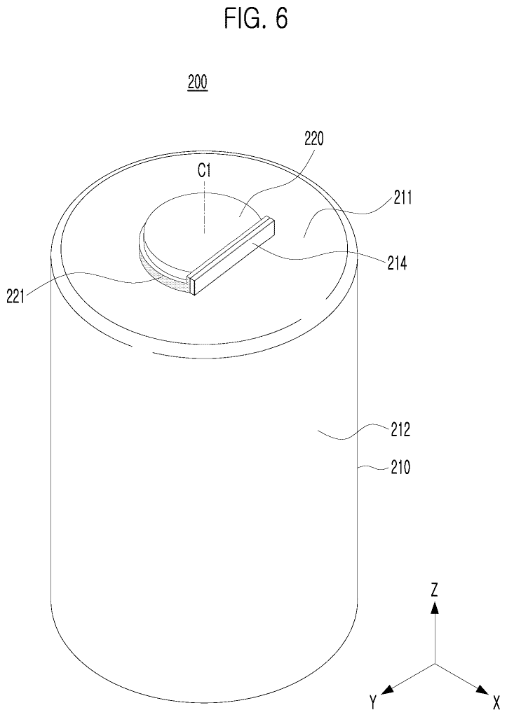

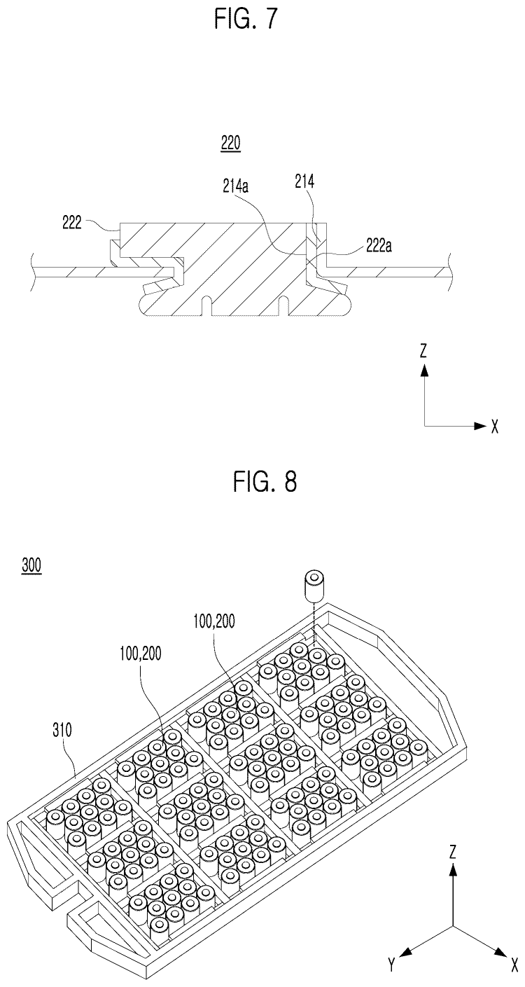

FIG. 6 is a schematic perspective view of a secondary battery according to another embodiment of the present disclosure. FIG. 7 is a schematic cross-sectional view of the rivet shown in FIG. 6.

Hereinafter, for convenience, differences from the above-described embodiment will be mainly described.

Referring to FIGS. 6 and 7, in some embodiments, a secondary battery 200 may include a can 210 and a rivet 220. The can 210 may include an upper surface portion 211 and a side surface portion 212, and may accommodate an electrode assembly therein. In addition, the rivet 220 may be disposed on the upper surface portion 211 of the can 210. The rivet 220 may be electrically insulated from the can 210 through a gasket 221 and may seal the inside of the can 210.

In some embodiments, the can 210 may have a bent rib 214 on the upper surface portion 211, and a first rotational support surface 214a may be provided on the bent rib 214. In addition, the rivet 220 may have a second rotational support surface 222a on a side surface 222, and the second rotational support surface 222a may be supported by the first rotational support surface 214a to limit the rotation of the rivet 220. In the illustrated embodiment, the second rotational support surface 222a may formed to extend to an upper end of the rivet 220. Accordingly, the planar shape of the rivet 220 may be provided in a shape in which a circular shape is partially cut along a predetermined chord. That is, the rivet 220 may be formed similar to the shape in which the upper area A3 of the rivet 120 is removed in the above-described embodiment.

The upper surface of the rivet 220 described above is not maintained in a circular shape. That is, the second rotational support surface 222a may be exposed on the upper surface of the rivet 220, and the upper surface of the rivet 220 may have directionality based on the second rotational support surface 222a in a plan view. For example, the secondary battery 200 may be arranged such that the second rotational support surface 222a corresponds to the x-axis direction or the y-axis direction, and such an arrangement direction may be easily identified from the outside through the second rotational support surface 222a. In some embodiments, such an arrangement direction of the second rotational support surface 222a may be utilized to identify the secondary battery 200. For example, the arrangement direction of the second rotational support surface 222a may be used to identify an electrical connection method (e.g., series or parallel) of the secondary battery 100 in the battery pack, or to identify a specific secondary battery 200 in which a defect occurs.

FIG. 8 is a schematic perspective view of a battery pack according to one embodiment of the present disclosure.

Meanwhile, according to another aspect of the present disclosure, a battery pack 300 including the secondary battery 100 or 200 described above may be provided. Referring to FIG. 8, in some embodiments, the battery pack 300 may include a case 310 and a plurality of secondary batteries 100 or 200 disposed in the case 310. The secondary batteries 100 and 200 may be provided the same as or similar to the secondary batteries 100 and 200 of the above-described embodiments. In some embodiments, the secondary batteries 100 or 200 disposed in the battery pack 300 may be referred to as ‘battery cells.’ The case 310 may provide an arrangement space in which the plurality of secondary batteries 100 or 200 may be disposed. The case 310 may be provided in various shapes, structures, and the like according to a specific device in which the battery pack 300 is used.

In some embodiments, the case 310 may be partially or wholly integrated into a device in which the battery pack 300 is used. Alternatively, the case 310 may be partially or entirely replaced by a structure or the like constituting the device. For example, the case 310 may be partially or wholly integrated into the chassis, body, or the like of the vehicle, or may be replaced by the chassis, body, or the like. In other words, the term ‘battery pack 300’ used in this description is not necessarily limited to a typical battery pack 300 in an independent form, but may encompass various types of structures that allow the secondary batteries 100 and 200 to be mounted on a specific device.

As described above, embodiments of the present disclosure may provide a secondary battery and a battery pack including the same.

In addition, at least some embodiments of the present disclosure may include a rivet that functions as an electrode terminal, and rotation of the rivet around a rivet axis may be supported by the can. Accordingly, the movement of the rivet due to an external force may be prevented, and problems such as electrical disconnection and sealing reduction due to the movement of the rivet may be prevented.

In addition, at least some embodiments of the present disclosure may prevent the movement of the rivet as described above through the first and second rotational support surfaces. Since the first and second rotational support surfaces have a structure in which the corresponding surfaces are supported by contact over a relatively large area, the rivet movement can be firmly and stably supported. In addition, the gasket disposed between the first and second rotational support surfaces may contribute to more completely closely supporting the first and second rotational support surfaces without gaps, thereby further improving the support force of the first and second rotational support surfaces.

In addition, at least some embodiments of the present disclosure may be easily implemented at a relatively low cost despite the above advantages. In addition, the can, rivet, and the like proposed in the embodiments of the present disclosure may be implemented with only partial modifications to existing typical cans, rivets, and the like.

Embodiments of the present disclosure can provide a secondary battery and a battery pack including the same.

In addition, at least some embodiments of the present disclosure can include a rivet that functions as an electrode terminal, and rotation of the rivet around a rivet axis can be supported by a can. Accordingly, the movement of the rivet due to an external force can be prevented, and problems such as electrical disconnection and sealing reduction due to the movement of the rivet can be prevented.

In addition, according to at least some embodiments of the present disclosure, the movement of the rivet as described above can be prevented through first and second rotational support surfaces. Since the first and second rotational support surfaces have a structure in which the corresponding surfaces are supported by contact over a relatively large area, the rivet movement can be firmly and stably supported. In addition, a gasket disposed between the first and second rotational support surfaces can contribute to more completely closely supporting the first and second rotational support surfaces without gaps, thereby further improving the support force of the first and second rotational support surfaces.

In addition, at least some embodiments of the present disclosure can be easily implemented at a relatively low cost despite the above advantages. In addition, the can, rivet, and the like proposed in the embodiments of the present disclosure may be implemented with only partial modifications to existing typical cans, rivets, and the like.

The above description is only an example to which the principle of the present disclosure is applied, and other configurations may be further included without departing from the scope of the present disclosure.

What is claimed is:

1. A secondary battery comprising:
a can;
an electrode assembly disposed inside the can; and
a rivet provided on one surface of the can and electrically connected to a first electrode of the electrode assembly,
wherein the rivet is configured so that rotation around a rivet axis is supported by the can.

2. The secondary battery of claim 1, wherein the can includes a first rotational support surface that restricts rotation of the rivet.

3. The secondary battery of claim 2, wherein the first rotational support surface is provided on a bent rib formed by bending a portion of the can.

4. The secondary battery of claim 3, wherein the bent rib is formed by being bent toward an outside of the can.

5. The secondary battery of claim 2, wherein the first rotational support surface is formed as a plane parallel to the rivet axis.

6. The secondary battery of claim 1, wherein the rivet includes a second rotational support surface supported on the can to restrict rotation of the rivet.

7. The secondary battery of claim 6, wherein, the second rotational support surface is formed in a form in which a side surface of the rivet is partially cut.

8. The secondary battery of claim 6, wherein the rivet has a side surface formed to extend in a circumferential direction centered on the rivet axis.

9. The secondary battery of claim 8, wherein the second rotational support surface is formed in a form in which the side surface is partially cut along a predetermined chord.

10. The secondary battery of claim 9, wherein the second rotational support surface is formed to have a center angle of 30 to 120 degrees centered on the rivet axis in a plan view.

11. The secondary battery of claim 6, wherein the second rotational support surface is formed as a plane parallel to the rivet axis.

12. The secondary battery of claim 1, wherein the rivet includes:
a lower area disposed inside the can and electrically connected to the first electrode;
a central area extending from the lower area toward an outside of the can; and
an upper area extending from the central area to form an upper end of the rivet.

13. The secondary battery of claim 12, wherein the second rotational support surface is partially provided in the central area.

14. The secondary battery of claim 12, wherein the upper area is formed in a circular shape centered on the rivet axis in a plan view, and
the second rotational support surface is formed in a shape in which the circular shape is partially cut along a predetermined chord in a plan view.

15. The secondary battery of claim 1, further comprising a gasket provided between the rivet and the can to electrically insulate the rivet and the can.

16. The secondary battery of claim 1, wherein the can is formed in a cylindrical shape, and
the electrode assembly is formed by winding the first electrode and a second electrode in a roll shape with a separator interposed therebetween.

17. The secondary battery of claim 16, wherein the electrode assembly includes:
a first electrode surface formed by bending a plurality of first electrode tabs toward a central axis at one surface of the electrode assembly; and
a second electrode surface formed by bending a plurality of second electrode tabs toward the central axis at an opposite surface corresponding to the one surface.

18. A battery pack comprising the secondary battery of claim 1.
